(19) United States
(12) Patent Application Publication
(10) Pub. No.: US 2016/0040748 A1
(43) Pub. Date: Feb. 11, 2016

(54) HELICAL FLEXPLATE ASSEMBLY AND SYSTEMS INCORPORATING THE SAME

(71) Applicant: BorgWarner Inc., Auburn Hills, MI (US)

(72) Inventors: Brett Peglowski, Oakland, MI (US); Keith Martin, Marlette, MI (US)

(21) Appl. No.: 14/453,971

(22) Filed: Aug. 7, 2014

(51) Int. Cl. F16F 15/30; F02N 11/00

(52) U.S. Cl. CPC F16F 15/30; F02N 11/00

(57) ABSTRACT

A flexplate assembly for use in translating rotational torque between a starter motor, an engine, and a transmission is provided. The flexplate assembly includes a drive assembly and a ring assembly. The drive assembly is operatively attached to the engine and the transmission and is used to translate rotational torque therebetween. The ring assembly includes a helical ring gear permanently engaging the starter motor. The ring assembly is in freewheel rotational communication with the drive assembly such that the ring assembly couples to and rotates with the drive assembly in response to rotational torque generated by the starter motor, and wherein the drive assembly disengages from the ring assembly in response to rotational torque generated by the engine.

### BACKGROUND OF INVENTION

1. Field of Invention

The present invention relates, generally, to powertrain starting systems and, more specifically, to a helical flexplate assembly and systems incorporating the same.

2. Description of the Related Art

Conventional automotive powertrain starting systems known in the art typically include an internal combustion engine controlled by an Engine Control Unit (ECU). The engine generates rotational torque through a crankshaft which is typically in rotational communication with a transmission. A ring gear is typically disposed between the engine and transmission. Depending on the type of transmission, the ring gear may be integrated on a clutch flywheel, a flexplate to which a torque converter or modular clutch assembly is attached, or on any powertrain component in rotational communication with the crankshaft. The ring gear cooperates with a pinion gear of a starter motor to rotate the engine at startup. To that end, conventional starter motors tend to simultaneously rotate and move the pinion gear into engagement with the ring gear, creating a distinctive noise as teeth of the rotating pinion gear engage teeth of the stationary ring gear.

So-called “permanently engaged” starter systems are also known in the art, wherein the pinion gear of the starter motor does not move and is always engaging the ring gear in operation. However, the ring gear typically rotates as the engine runs and, thus, rotates the pinion gear of the starter as well, which generates noise and reduces the efficiency of the engine.

Each of the components of a powertrain starting system of the type described above must cooperate to effectively start the engine. In addition, each of the components must be designed not only to facilitate improved performance and efficiency, but also so as to reduce the cost and complexity of manufacturing and assembling the system. While starting systems known in the related art have generally performed well for their intended purpose, there remains a need in the art for a starting system that has superior operational characteristics, and, at the same time, reduces the cost and complexity of manufacturing the components of the system, as well as the amount of noise generated in operation.

### SUMMARY OF THE INVENTION

The present invention overcomes the disadvantages in the related art in a flexplate assembly for use in translating rotational torque between a starter motor, an engine, and a transmission. The flexplate assembly includes a drive assembly and a ring assembly. The drive assembly is operatively attached to the engine and the transmission and is used to translate rotational torque therebetween. The ring assembly includes a helical ring gear permanently engaging the starter motor. The ring assembly is in freewheel rotational communication with the drive assembly such that the ring assembly couples to and rotates with the drive assembly in response to rotational torque generated by the starter motor, and wherein the drive assembly disengages from the ring assembly in response to rotational torque generated by the engine.

In addition, the present invention is directed toward a system for use in starting an engine and translating rotational torque between the engine and a transmission. The system includes a starter motor, a drive assembly, and a ring assembly. The starter motor is operatively attached to at least one of the engine and the transmission and includes a helical pinion gear. The drive assembly is operatively attached to the engine and the transmission, and is used to translate rotational torque therebetween. The ring assembly includes a helical ring gear permanently engaging the helical pinion gear of the starter motor. The ring assembly is in freewheel rotational communication with the drive assembly such that the ring assembly couples to and rotates with the drive assembly in response to rotational torque generated by the starter motor, and wherein the drive assembly disengages from the ring assembly in response to rotational torque generated by the engine.

Further, the present invention is directed toward a method of starting and operating a vehicle having an engine operatively attached to a transmission. The method includes the steps of: providing an engine control unit for selectively driving the engine to generate rotational torque; providing a starter motor operatively attached to at least one of the engine and the transmission, the starter motor having a helical pinion gear; providing a flexplate assembly disposed between the engine and the transmission, the flexplate assembly including: a drive assembly operatively attached to the engine and the transmission for translating rotational torque therebetween, and a ring assembly having a helical ring gear permanently engaging the starter motor, the ring assembly being in selective freewheel rotational communication with the drive assembly, and the flexplate assembly being movable between a freewheel configuration and a locked configuration in response to a predetermined rotational torque differential occurring between the drive assembly and the ring assembly; rotating the starter motor such that the helical pinion gear rotates and translates rotational torque to the helical ring gear of the drive assembly thereby causing the flexplate assembly to move to the locked configuration and subsequently rotate the engine; detecting a rotational speed of the engine with the engine control unit; simultaneously stopping the starter motor and driving the engine with the engine control unit in response to the engine reaching a predetermined rotational speed; and generating rotational torque with the engine in response to being driven by the engine control unit such that the flexplate assembly moves to the freewheel configuration in response to a predetermined rotational torque differential occurring between the ring assembly and the drive assembly.

In this way, the present invention significantly reduces the complexity, noise generation, and packaging size of the starting system and its associated components. Moreover, the present invention reduces the cost of manufacturing starter systems that have superior operational characteristics, such as improved engine performance, control, and efficiency.

### BRIEF DESCRIPTION OF THE DRAWINGS

Other objects, features, and advantages of the present invention will be readily appreciated as the same becomes better understood after reading the subsequent description taken in connection with the accompanying drawing wherein:

FIG. 1 is a partial perspective view of an automotive engine showing a flexplate assembly, according to one embodiment of the present invention.

FIG. 2 is a partial exploded perspective view components of the engine of FIG. 1, showing a starter, crankshaft output, torque converter, and the flexplate assembly of FIG. 1.

FIG. 3 is an enlarged perspective view of the flexplate assembly of FIGS. 1 and 2.

FIG. 4 is a partially exploded perspective view of the flexplate assembly of FIG. 3 showing a drive assembly and a ring assembly.

FIG. 5 is an enlarged perspective view of the drive assembly of FIG. 4.

FIG. 6 is an alternate perspective view of the drive assembly of FIG. 5.

FIG. 7A is angled sectional view taken along line 7A-7A of FIG. 3.

FIG. 7B is an enlarged partial sectional view taken from circle 7B of FIG. 7A.

### DETAILED DESCRIPTION OF THE INVENTION

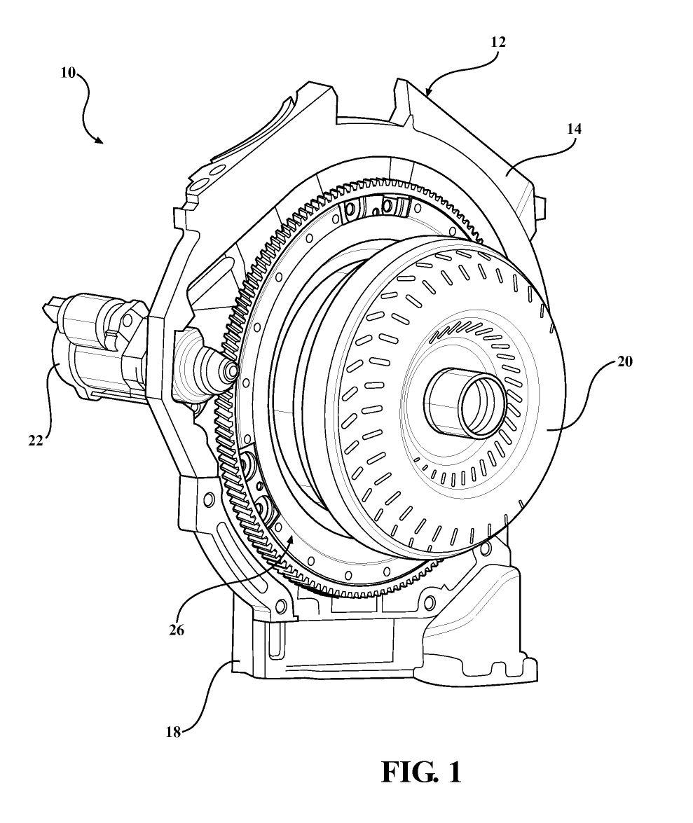

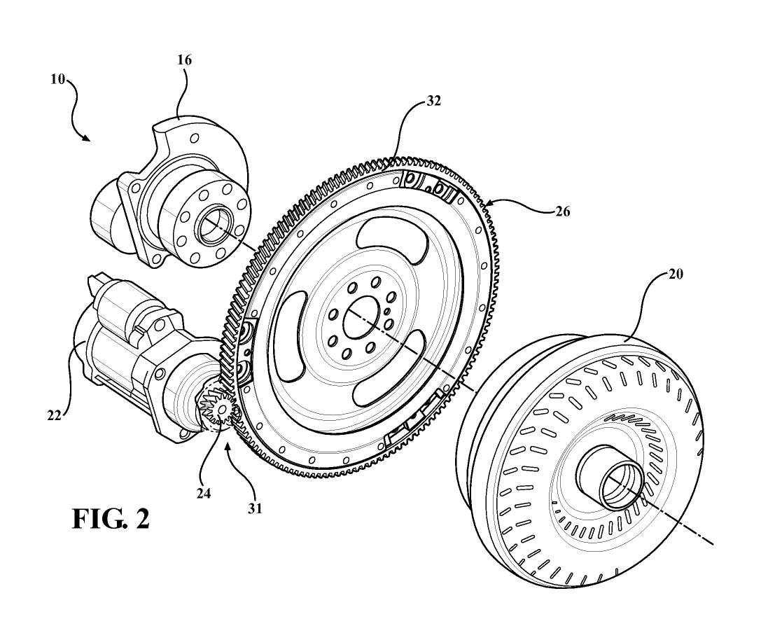

Referring now to the figures, where like numerals are used to designate like structure, a portion of a powertrain of an automobile is illustrated at 10 in FIGS. 1 and 2. The powertrain 10 includes an internal combustion engine 12 operatively attached to a transmission (not shown, but generally known in the art). The engine 12 is adapted to generate and translate rotational torque to the transmission and includes a block 14 and a crankshaft 16 (see FIG. 2) rotatably supported in the block 14. The engine 12 also typically includes an oil pan 18 attached to the block 14. While the engine 12 illustrated in FIGS. 1 and 2 is a V-configured, dual-overhead-cam (DOHC), spark-ignition Otto-cycle engine, those having ordinary skill in the art will appreciate that the engine 12 could be of any suitable configuration controlled using any suitable thermodynamic cycle without departing from the scope of the present invention.

The powertrain 10 also typically includes a disengagement member 20 in rotational communication with the crankshaft 16 for controlling engagement between the engine 12 and transmission. As shown in FIGS. 1 and 2, the disengagement member 20 is a torque converter 20, conventionally used in conjunction with automatic transmissions as well as certain types of continuously-variable transmissions. However, those having ordinary skill in the art will appreciate that the disengagement member 20 could be of any type or configuration suitable to control engagement between the engine 12 and transmission so as to selectively translate rotational torque therebetween, without departing from the scope of the present invention. By way of non-limiting example, the disengagement member 20 could be a clutch assembly (not shown, but generally known in the art) used in conjunction with a manual transmission.

To start the engine 12, a starter motor 22 is typically operatively attached to one of the engine 12 and the transmission, and is in selective rotational communication with the crankshaft 16. To that end, and according to one embodiment of the present invention, the starter motor 22 includes a helical pinion gear 24 that cooperates with a flexplate assembly 26 to rotate the engine 12 at startup. The flexplate assembly 26 is used to translate rotational torque between the starter motor 22, the engine 12, and the transmission. More specifically, and as illustrated in FIGS. 1 and 2, the flexplate assembly 26 is operatively attached to the crankshaft 16 and the disengagement member 20 (torque converter) and is used to translate rotational torque therebetween so as to control engagement between the engine 12 and the transmission. However, those having ordinary skill in the art will appreciate that the engine 12 can be used to translate rotational torque to any suitable type of input and, thus, that the flexplate assembly 26 of the present invention can be used in conjunction with the engine 12 irrespective of the presence of a transmission and/or a disengagement member 20. By way of non-limiting example, and as will be appreciated from the description of the flexplate assembly 26 below, it is conceivable that the engine 12 could be connected directly to an output shaft (not shown, but generally known in the art) and could cooperate with the flexplate assembly 26 of the present invention at startup without the use of a transmission or a disengagement member 20. Further, it will be appreciated that neither the engine 12 nor the transmission form a part of the flexplate assembly 26 of the present invention, and are described herein for the purpose of clarity and as an example of one use of the flexplate assembly 26 in the method described in greater detail below.

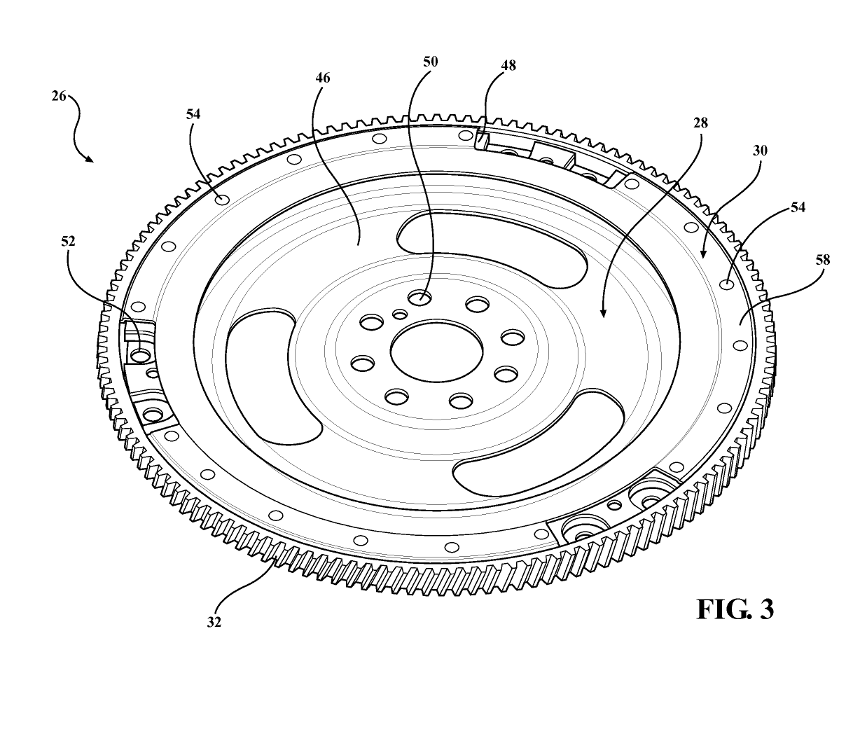

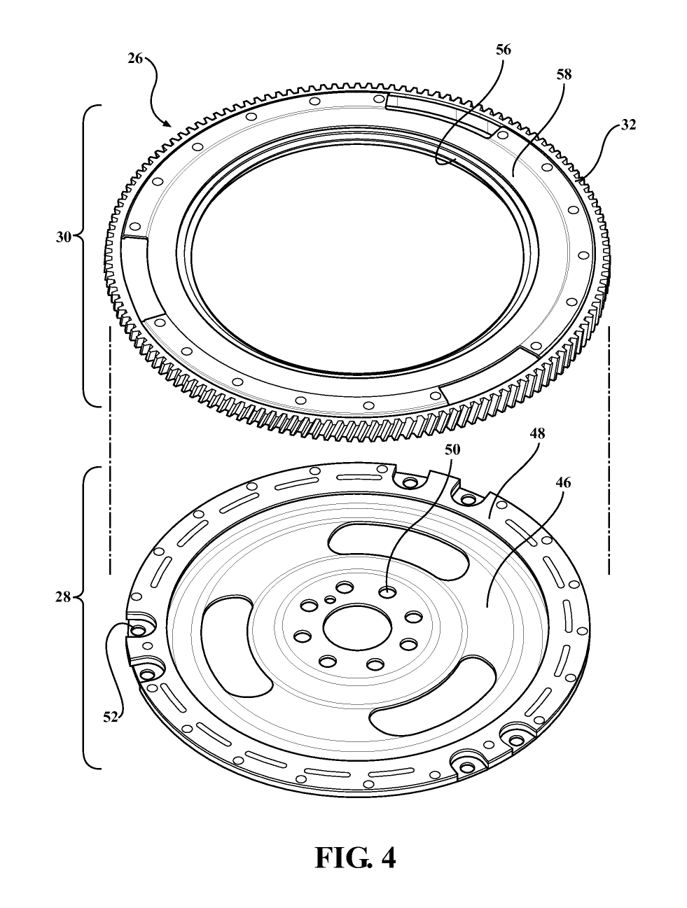

Referring now to FIGS. 1-4, the flexplate assembly 26 includes a drive assembly 28 and a ring assembly 30. In one embodiment, the drive assembly 28, ring assembly 30, and starter motor 22 define a system 31 for translating rotational torque between the engine 12 and transmission. More specifically, the drive assembly 28 is operatively attached to the engine 12 and the transmission for translating rotational torque therebetween. To that end, and as shown best in FIG. 2, the drive assembly 28 is concentrically aligned with and operatively attached to both the crankshaft 16 and the disengagement member 20. The ring assembly 30 includes a helical ring gear 32 permanently engaging the helical pinion gear 24 of the starter motor 22 (see FIG. 2). The ring assembly 30 is in freewheel rotational communication with the drive assembly 28 such that the ring assembly 30 couples to and rotates with the drive assembly 28 in response to rotational torque generated by the starter motor 22, and wherein the drive assembly 28 disengages from the ring assembly 30 in response to rotational torque generated by the engine 12. The drive assembly 28 and ring assembly 30 will be described in greater detail below.

As noted above, the system 31 enables the starter motor 22 to be permanently engaged to the flexplate assembly 26, whereby the helical pinion gear 24 of the starter motor is permanently meshed with the helical ring gear 32 of the ring assembly 30 of the flexplate assembly 26. The helical teeth are spaced diagonally with respect to gear rotation, which improves tooth-to-tooth engagement and thereby allows flexibility with respect to the design, spacing, size, and orientation of the helical ring gear 32 and helical pinion gear 24. Moreover, the helical profiles of the ring gear 32 and pinion gear 24 significantly reduces noise generation, thus enabling the engine 12 to be started quietly, which also contributes to an improved start-stop driving experience. Further, as will be appreciated from the description of the drive assembly 28 and ring assembly 30 below, the relationship between the helical pinion gear 24 of the starter motor 22 and the helical ring gear 32 of the flexplate assembly 26 enables improved flexibility in the design, sizing, and orientation of the starter motor 22 and the flexplate assembly 26, whereby the overall weight and packaging size of the system 31 can be reduced.

As shown best in FIG. 6, in one embodiment, the drive assembly 28 includes a plurality of radially-spaced rollers 34 at least partially engaging the ring assembly 30. The rollers 34 are used to translate freewheel rotational communication between the drive assembly 28 and the ring assembly 30. In one embodiment, the rollers 34 have a substantially cylindrical shape. However, those having ordinary skill in the art will appreciate that the rollers 34 could have any shape or be of any type or configuration suitable to translate freewheel rotational communication between the drive assembly 28 and the ring assembly 30 without departing from the scope of the present invention. Moreover, it will be appreciated that the rollers 34 could be omitted from the flexplate assembly 26 without departing from the scope of the present invention.

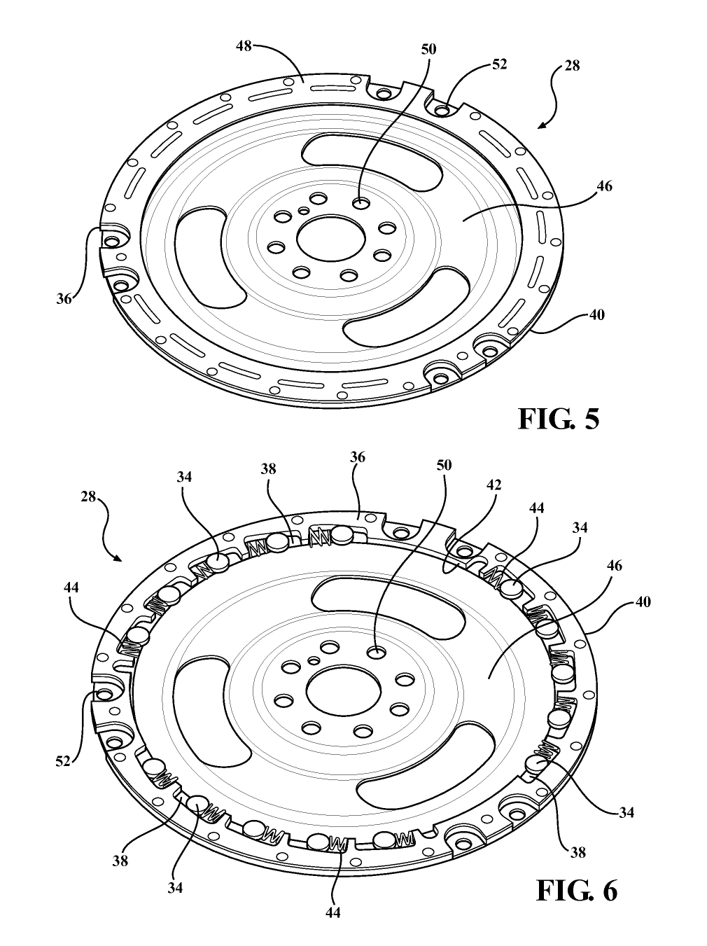

Referring now to FIGS. 5 and 6, in one embodiment, the drive assembly 28 includes an interface ring 36 spaced from the engine 12 and transmission. The interface ring 36 has a plurality of radially-spaced apertures 38 defined therein, with the rollers 34 at least partially disposed in and moveable along the apertures 38. As shown in FIG. 6, the interface ring 36 includes ten apertures 38 and a corresponding ten rollers 34. However, those having ordinary skill in the art will appreciate that any suitable number of apertures 38 and/or rollers 34 could be used without departing from the scope of the present invention. In one embodiment, the interface ring 36 has an outer portion 40 and an inner portion 42, with the apertures 38 defined along and merging with the inner portion 42, whereby the rollers 34 extend beyond the inner portion 42 (see FIG. 6) and interact with the ring assembly 30 as described in greater detail below. However, those having ordinary skill in the art will appreciate that the rollers 34 could be disposed in any suitable location with respect to the interface ring 36 without departing from the scope of the present invention. Further, in one embodiment, the apertures 38 have a tapered profile such that the rollers 34 move radially inwardly with respect to the inner portion 42 of the interface ring 36 as the rollers 34 move along said apertures 38. However, those having ordinary skill in the art will appreciate that the apertures 38 could have any suitable profile without departing from the scope of the present invention.

As noted above, the rollers 34 interact with the ring assembly 30 so as to effect freewheel rotational communication of the flexplate assembly 26. To that end, and in one embodiment, the drive assembly 28 may include a plurality of springs 44 disposed in the apertures 38 and at least partially engaging the rollers 34 for biasing the rollers 34 within the apertures 38. As shown best in FIG. 6, the springs 44 are accordion compression springs 44. However, those having ordinary skill in the art will appreciate that any spring 44 of any suitable type or configuration could be utilized without departing from the scope of the present invention. Further, it will be appreciated that the springs 44 could be either partially or entirely omitted without departing from the scope of the present invention. To that end, it is conceivable that the rollers 34 could be configured to move along and within the apertures 38 of the interface ring 36 without the use of springs 44, whereby at least one of rotational inertia and centrifugal force moves the rollers 34 into engagement with the ring assembly 30 the in operation. Moreover, it is conceivable that less than all of the rollers 34 could have corresponding springs 44. Similarly, it will be appreciated that springs 44 having different properties from one another could be utilized. By way of non-limiting example, one or more springs 44 in the same flexplate assembly 26 could have different spring rates, free lengths, solid lengths, cross-sectional profiles, wire sizes, rate profiles, frequency profiles, etc. without departing from the scope of the present invention. Similarly, the springs 44 could have different materials, processing, heat treatment, etc. from one another without departing from the scope of the present invention. Thus, it will be appreciated that one or more of the springs 44 could be substituted, omitted, or otherwise changed depending on the specific requirements of the application of the flexplate assembly 26.

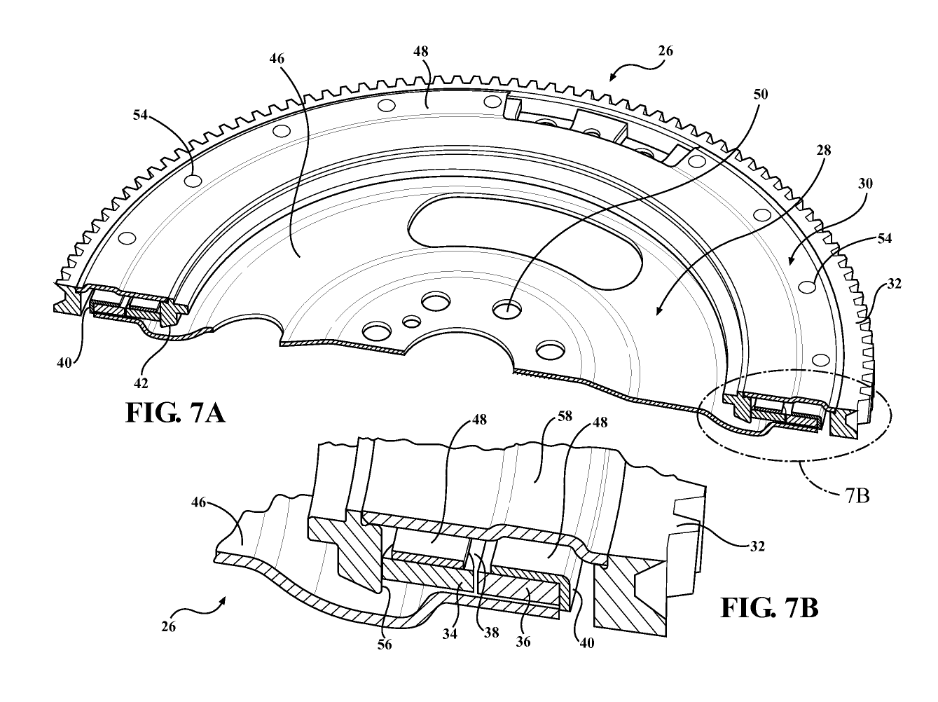

In one embodiment, and as best shown in FIGS. 5-7B, the drive assembly 28 includes a drive plate 46 and a retaining plate 48. The drive plate 46 is operatively attached to the engine 12 and the transmission. To that end, as best shown in FIGS. 5 and 6, the drive plate may include a plurality of radially-spaced inner holes 50 and outer holes 52, for attaching to the crankshaft 16 and the disengagement member 20, respectively. However, it will be appreciated that the drive plate 46 could be operatively attached to the engine 12 and transmission in different ways without departing from the scope of the present invention. Similarly, while the retaining plate 48 is operatively attached to the drive plate 46 with a plurality of radially-spaced rivets 54, it will be appreciated that the retraining plate 48 could be operatively attached to the drive plate 46 in any suitable way without departing from the scope of the present invention. Further, at least one of the interface ring 36 and the rollers 34 are at least partially disposed between the drive plate 46 and the retaining plate 48 (see FIG. 7B).

In one embodiment, and as best shown in FIGS. 7A-7B, the ring assembly 30 further includes an inner race 56 and a shell 58. The inner race 56 engages the rollers 34 of the drive assembly 28, as described above, the shell 58 extends between and merges with the inner race 56 and the helical ring gear 32. While the inner race 56, shell 58, and helical ring gear 32 are operatively attached to one another by welding, those having ordinary skill in the art will appreciate that any suitable type of attachment could be utilized without departing from the scope of the present invention.

As noted above, the present invention is also directed toward a method of starting and operating a vehicle (not shown, but generally known in the art) having an engine 12 operatively attached to a transmission. The engine 12 is controlled by an engine control unit (not shown, but generally known in the art). The method includes the steps of: providing an engine control unit for selectively driving the engine 12 to generate rotational torque; providing a starter motor 22 operatively attached to at least one of the engine 12 and the transmission, the starter motor 22 having a helical pinion gear 24; providing a flexplate assembly 26 disposed between the engine 12 and the transmission, the flexplate assembly 26 including: a drive assembly 28 operatively attached to the engine 12 and the transmission for translating rotational torque therebetween, and a ring assembly 30 having a helical ring gear 32 permanently engaging the helical pinion gear 24 of the starter motor 22, the ring assembly 30 being in selective freewheel rotational communication with the drive assembly 28, the flexplate assembly 26 being movable between a freewheel configuration and a locked configuration in response to a predetermined rotational torque differential occurring between the drive assembly 28 and the ring assembly 30; rotating the starter motor 22 such that the helical pinion hear 24 rotates and translates rotational torque to the helical ring gear 32 of the drive assembly 28 thereby causing the flexplate assembly 26 to move to the locked configuration and subsequently rotate the engine 12; detecting a rotational speed of the engine 12 with the engine control unit 60; simultaneously stopping the starter motor 22 and driving the engine 12 with the engine control unit in response to the engine 12 reaching a predetermined rotational speed; and generating rotational torque with the engine 12 in response to being driven by the engine control unit such that the flexplate assembly 26 moves to the freewheel configuration in response to a predetermined rotational torque differential occurring between the ring assembly 30 and the drive assembly 28.

In one embodiment, the method described above includes the further steps of: driving the vehicle using rotational torque generated by the engine 12 and translated through the flexplate assembly 26 to the transmission; and stopping rotation of the engine 12 with the engine control unit in response to the vehicle reaching a predetermined speed.

In this way, the invention significantly reduces the complexity, cost, and packaging size of powertrain 10 systems and associated components. Specifically, it will be appreciated that the present invention provides significant advantages relating to elimination of noise, vibration, and harshness (NVH) traditionally associated with conventional starting systems 31. To that end, the helical ring gear 32 of the flexplate assembly 26 and helical pinion gear 24 of the starter motor 22 cooperate to provide smooth, consistent, and quiet engagement so as to start the engine 12 in operation. Moreover, it will be appreciated that the flexplate assembly 26 and starting system 31 of the present invention can be used in conjunction with any suitable type of powertrain 10, irrespective of the type of transmission or lubrication used. Further still, the present invention reduces the cost of manufacturing powertrain 10 starting systems 31 and components that have superior operational characteristics, such as improved performance, weight, component life and longevity, and efficiency.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A flexplate assembly for use in translating rotational torque between a starter motor, an engine, and a transmission, said flexplate assembly comprising:
a drive assembly operatively attached to the engine and the transmission for translating rotational torque therebetween; and
a ring assembly having a helical ring gear permanently engaging the starter motor, said ring assembly being in freewheel rotational communication with said drive assembly such that said ring assembly couples to and rotates with said drive assembly in response to rotational torque generated by the starter motor, and wherein said drive assembly disengages from said ring assembly in response to rotational torque generated by the engine.

2. The flexplate assembly as set forth in claim 1, wherein said drive assembly includes a plurality of radially-spaced rollers at least partially engaging said ring assembly for translating freewheel rotational communication between said drive assembly and said ring assembly.

3. The flexplate assembly as set forth in claim 2, wherein said rollers have a substantially cylindrical shape.

4. The flexplate assembly as set forth in claim 2, wherein said drive assembly further includes an interface ring spaced from the engine and the transmission, said interface ring having a plurality of radially-spaced apertures defined therein, with said rollers at least partially disposed in and movable along said apertures.

5. The flexplate assembly as set forth in claim 4, wherein said interface ring has an outer portion and an inner portion, with said apertures defined along and merging with said inner portion.

6. The flexplate assembly as set forth in claim 5, wherein said apertures have a tapered profile such that said rollers move radially inwardly with respect to said inner portion of said interface ring as said rollers move along said apertures.

7. The flexplate assembly as set forth in claim 4, wherein said drive assembly further includes a plurality of springs disposed in said apertures and at least partially engaging said rollers for biasing said rollers within said apertures.

8. The flexplate assembly as set forth in claim 4, wherein said drive assembly further includes:
a drive plate operatively attached to the engine and the transmission; and
a retaining plate operatively attached to said drive plate,
with at least one of said interface ring and said rollers being least partially disposed between said drive plate and said retaining plate.

9. The flexplate assembly as set forth in claim 2, wherein said ring assembly further includes:
an inner race for engaging said rollers of said drive assembly; and
a shell extending between and merging with said inner race and said helical ring gear.

10. A system for use in starting an engine and translating rotational torque between the engine and a transmission, said system comprising:
a starter motor operatively attached to at least one of the engine and the transmission, said starter motor having a helical pinion gear;
a drive assembly operatively attached to the engine and the transmission for translating rotational torque therebetween; and
a ring assembly having a helical ring gear permanently engaging said helical pinion gear of said starter motor, said ring assembly being in freewheel rotational communication with said drive assembly such that said ring assembly couples to and rotates with said drive assembly in response to rotational torque generated by said starter motor, and wherein said drive assembly disengages from said ring assembly in response to rotational torque generated by the engine.

11. The system as set forth in claim 10, wherein said drive assembly includes a plurality of radially-spaced rollers at least partially engaging said ring assembly for translating freewheel rotational communication between said drive assembly and said ring assembly.

12. The system as set forth in claim 11, wherein said rollers have a substantially cylindrical shape.

13. The system as set forth in claim 11, wherein said drive assembly further includes an interface ring spaced from the engine and the transmission, said interface ring having a plurality of radially-spaced apertures defined therein, with said rollers at least partially disposed in and movable along said apertures.

14. The system as set forth in claim 13, wherein said interface ring has an outer portion and an inner portion, with said apertures defined along and merging with said inner portion.

15. The system as set forth in claim 14, wherein said apertures have a tapered profile such that said rollers move radially inwardly with respect to said inner portion of said interface ring as said rollers move along said apertures.

16. The system as set forth in claim 13, wherein said drive assembly further includes a plurality of springs disposed in said apertures and at least partially engaging said rollers for biasing said rollers within said apertures.

17. The system as set forth in claim 13, wherein said drive assembly further includes:
a drive plate operatively attached to the engine and the transmission; and
a retaining plate operatively attached to said drive plate,
with at least one of said interface ring and said rollers being least partially disposed between said drive plate and said retaining plate.

18. The system as set forth in claim 11, wherein said ring assembly further includes:
an inner race for engaging said rollers of said drive assembly; and
a shell extending between and merging with said inner race and said helical ring gear.

19. A method of starting and operating a vehicle having an engine operatively attached to a transmission, said method comprising the steps of:
providing an engine control unit for selectively driving the engine to generate rotational torque;
providing a starter motor operatively attached to at least one of the engine and the transmission, said starter motor having a helical pinion gear;
providing a flexplate assembly disposed between the engine and the transmission, said flexplate assembly including: a drive assembly operatively attached to the engine and the transmission for translating rotational torque therebetween, and a ring assembly having a helical ring gear permanently engaging said starter motor, said ring assembly being in selective freewheel rotational communication with said drive assembly, and said flexplate assembly being movable between a freewheel configuration and a locked configuration in response to a predetermined rotational torque differential occurring between said drive assembly and said ring assembly;
rotating said starter motor such that said helical pinion gear rotates and translates rotational torque to said helical ring gear of said drive assembly thereby causing said flexplate assembly to move to said locked configuration and subsequently rotate the engine;
detecting a rotational speed of the engine with said engine control unit;
simultaneously stopping said starter motor and driving the engine with said engine control unit in response to the engine reaching a predetermined rotational speed;
generating rotational torque with the engine in response to being driven by said engine control unit such that said flexplate assembly moves to said freewheel configuration in response to a predetermined rotational torque differential occurring between said ring assembly and said drive assembly.

20. The method as set forth in claim 19, including the further steps of:
driving the vehicle using rotational torque generated by the engine and translated through said flexplate assembly to the transmission, and
stopping rotation of the engine with said engine control unit in response to the vehicle reaching a predetermined speed.
